(19) United States
(12) Patent Application Publication
(10) Pub. No.: US 2018/0234617 A1
(43) Pub. Date: Aug. 16, 2018

(54) MOTION CAMERA AUTOFOCUS SYSTEMS

(71) Applicant: John Przyborski, Pittsburgh, PA (US)

(72) Inventor: John Przyborski, Pittsburgh, PA (US)

(21) Appl. No.: 15/433,147

(22) Filed: Feb. 15, 2017

(51) Int. Cl. H04N 5/232; H04N 5/225; G06T 7/73; G06T 7/80; H04N 5/33

(52) U.S. Cl. CPC H04N 5/23212; H04N 5/2256; H04N 5/23216; H04N 5/33; H04N 5/23293; G06T 7/80; G06T 7/74

(57) ABSTRACT

Systems, measuring devices, and methods that continuously and automatically adjust the focus of a lens of a motion camera are described. A measuring device includes one or more infrared components that generate and receive one or more infrared signals for measuring a distance, a processing device, and a non-transitory, computer-readable storage medium. The non-transitory, computer-readable storage medium includes one or more programming instructions that, when executed, cause the processing device to continuously obtain data corresponding to a distance between a target object and a lens coupled to a motion camera from the one or more infrared components, determine one or more position parameters of the lens that corresponds to a focused image of the target object, and transmit the one or more position parameters to a lens controller, thereby causing the lens controller to adjust a positioning of the lens to correspond to the position parameters.

### BACKGROUND

### Field

The present specification generally relates to systems that automatically adjust the focus of a lens of a motion camera and, more particularly, to systems, measuring devices, and methods that continuously and automatically determine a distance to a target object and adjust the focus of the lens accordingly.

### Technical Background

Currently, most light-based focus systems for motion cameras are integrated with the motion camera and/or a lens attached to the motion camera. The light-based focus systems may be specifically configured for a particular lens. That is, while motion cameras typically accept a wide array of lens, they do not have a focus system that can be adapted to and calibrated with the same wide array of lenses. In addition, the light-based focus systems can obtain distance information to a target object that is located within a field of view of the motion camera. That is, the light-based focus systems cannot be used to focus on a target object outside the field of view. Also, the target object is not definable by a user. As a result, light-based focus systems cannot maintain a continuous focus on the target object, such as when the target object moves relative to the motion camera and/or lens. Moreover, light-based focus systems generally determine a focus of a lens by analyzing an image captured by the motion camera instead of determining a focus of a lens independent of the image that is captured by the motion camera, which does not allow for focus on objects that are or could be outside a field of view of the lens and/or the camera.

Accordingly, a need exists for focus systems that allow a user to define a focus point, including focus points that may be located at changing positions within the image frame or completely outside a field of view of a motion camera. A need also exists for focus systems that determine a focus without analyzing an image captured by the motion camera. A need also exists for focus systems that can automatically or manually be configured for an offset distance between a measuring device and the camera lens. A need also exists for focus systems that can continuously maintain focus on a particular object, can adjust a speed of a transition between focus positions, and can be calibrated for use with any camera lens. Such a system that addresses these needs would improve camera focus in filmmaking, particularly in instances where capturing moving objects is necessary, such as in action scenes or the like.

### SUMMARY

In one embodiment, a measuring device includes one or more infrared components that generate and receive one or more infrared signals for measuring a distance, a processing device, and a non-transitory, processor-readable storage medium. The non-transitory, processor-readable storage medium includes one or more programming instructions that, when executed, cause the processing device to continuously obtain data corresponding to a distance between a target object and a lens coupled to a motion camera from the one or more infrared components, determine one or more position parameters of the lens that corresponds to a focused image of the target object, and transmit the one or more position parameters to a lens controller, thereby causing the lens controller to adjust a positioning of the lens to correspond to the position parameters.

In another embodiment, a method of continuously measuring a distance to a target object and adjusting a lens coupled to a motion camera to maintain a continuous focus on the target object includes continuously obtaining, by a processing device, data from one or more infrared components, where the data corresponds to the distance between the target object and the lens coupled to the motion camera. The method further includes determining, by the processing device, one or more position parameters of the lens that corresponds to a focused image of the target object and transmitting, by the processing device, the one or more position parameters to a lens controller, thereby causing the lens controller to adjust a positioning of the lens to correspond to the position parameters.

In yet another embodiment, a system includes a measuring device and a motion camera. The measuring device includes one or more infrared components that generate and receive one or more infrared signals for measuring a distance and a processing device for receiving data from the one or more infrared components, determining a distance, and transmitting one or more signals. The motion camera includes a lens, a lens ring that adjusts one or more of a focus, a zoom, and an aperture of the lens, and a lens controller coupled to the lens ring, the lens controller configured to move the lens ring. The measuring device continuously determines a distance between a target object and the lens, determines lens ring position parameters that correspond to the distance, and transmits signals to the lens controller for adjusting a positioning of the lens ring to correspond with the position parameters.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 is a schematic depiction of an illustrative system including a motion camera and a measuring device for automatically directing the focus of a lens coupled to the motion camera according to one or more embodiments shown and described herein;

FIG. 2 is a schematic depiction of the motion camera and the measuring device from FIG. 1, further illustrating hardware and software that may be used in automatically directing the focus of the lens according to one or more embodiments shown and described herein;

FIG. 3A depicts an illustrative user interface screen shot according to one or more embodiments shown and described herein;

FIG. 3B depicts another illustrative user interface screen shot according to one or more embodiments shown and described herein;

FIG. 3C depicts another illustrative user interface screen shot according to one or more embodiments shown and described herein;

FIG. 3D depicts another illustrative user interface screen shot according to one or more embodiments shown and described herein;

FIG. 3E depicts another illustrative user interface screen shot according to one or more embodiments shown and described herein;

FIG. 4A depicts a flow diagram of an illustrative method of receiving a calibration input and conducting a witness mark calibration according to one or more embodiments shown and described herein;

FIG. 4B depicts a flow diagram of and illustrative method of conducting another calibration process according to one or more embodiments shown and described herein; and

FIG. 5 depicts a flow diagram of an illustrative method of automatically directing the focus of a lens coupled to a motion camera according to one or more embodiments shown and described herein.

### DETAILED DESCRIPTION

Referring generally to the figures, embodiments described herein are directed to systems, measuring devices, and methods that continuously and automatically direct the focus of a lens coupled to a motion camera. In addition, embodiments described herein are directed to methods for calibrating the systems (or portions thereof) to a particular lens and/or methods for automatically directing the focus of the lens. The systems described herein generally include the motion camera and a measuring device. A control unit and a lens controller may be coupled to or integrated with the motion camera. In some embodiments, the camera may include a lens. The measuring device includes one or more measuring components (e.g., an IR emitter and/or an IR receiver), a user interface, and an offset measuring device. The measuring device may be communicably coupled to the camera. While the camera and the measuring device are depicted as wholly separate components, in some embodiments, the measuring device may be physically coupled to the motion camera, tethered to the motion camera, and/or the like.

As used herein, the term “motion camera” generally refers to any electronic device that can be used to capture images and sound. A motion camera includes both video cameras (cameras used for electronic motion picture acquisition) and movie cameras (cameras used for motion picture acquisition on film). To capture images, motion cameras are generally coupled to or integrated with a lens that directs light from outside the motion camera into an image sensor or film located within the motion camera. For the purposes of brevity, the term “camera” as used herein is intended to encompass all forms of motion cameras, and thus the terms “camera” and “motion camera” may be used interchangeably herein.

As used herein, the terms “continuously” and “continuous” encompass an act that is repeatedly conducted for any period of time, an act that occurs at an interval, or an act that occurs a plurality of times. For example, a trigger that is continuously depressed may be depressed and held in a depressed position for any period of time, may be depressed and released at particular intervals, or may be depressed and release a plurality of times. In another example, continuously obtaining data may include data that is obtained without pause for a particular period of time, may be obtained only at particular intervals, or may be obtained a plurality of times.

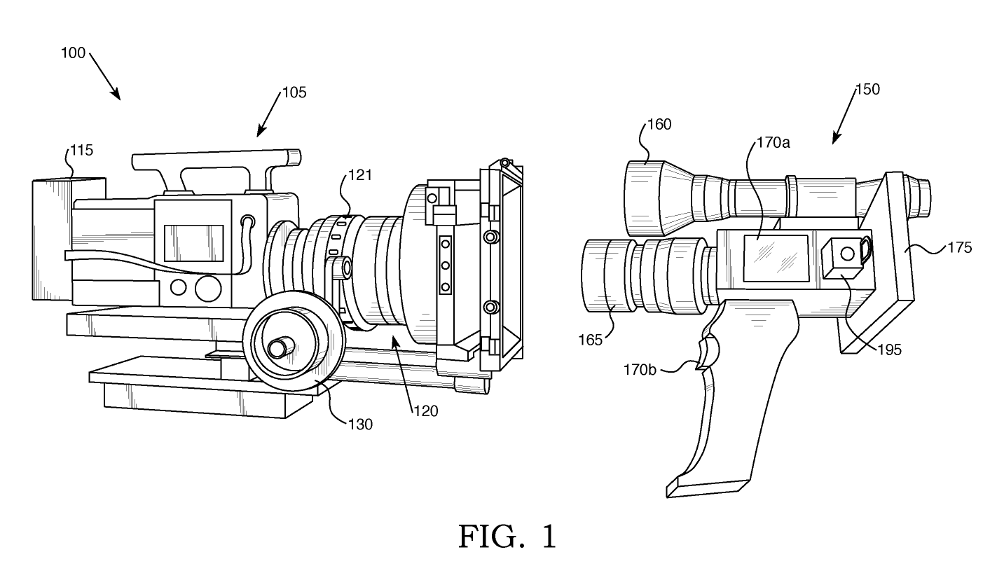

Referring now to the drawings, FIG. 1 depicts an illustrative system, generally designated 100, including a camera 105 and a measuring device 150. The camera 105 and the measuring device 150 may generally be distinct components that are communicatively coupled to one another, as described in further detail herein. However, it should be understood that the camera 105 and the measuring device 150 may also be physically coupled to one another in some embodiments. For example, the measuring device 150 may be mounted on a portion of the camera 105 or the camera 105 and the measuring device 150 may both be mounted to the same base (e.g., a tripod, a camera dolly, or the like).

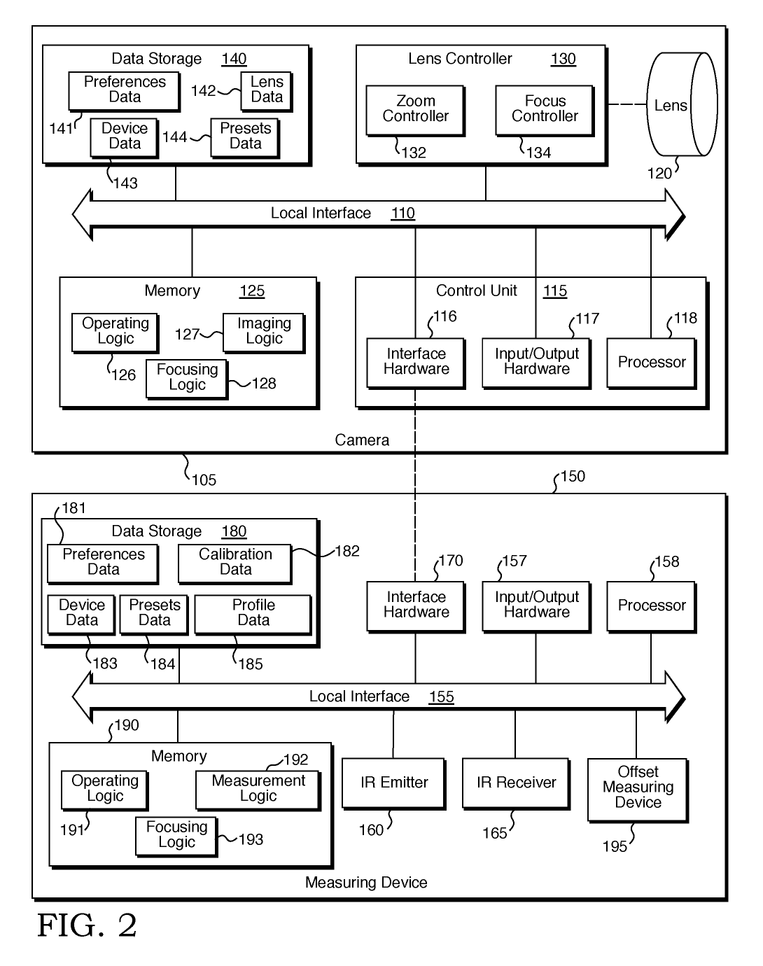

The camera 105 may be a standard motion camera as is generally understood. In some embodiments, the various components of the camera 105 described herein may be modified camera components such that they function with the various components of the measuring device 150. The camera 105 may be coupled to a control unit 115, a lens 120, and a lens controller 130. In addition, the camera 105 may incorporate the control unit 115, the lens 120, and/or the lens controller 130 among other components, particularly components that are generally recognized in a motion camera. The camera 105 may also include other internal components, as described herein with respect to FIG. 2.

The control unit 115 may generally be a device that receives signals, data, and/or the like, determines an adjustment that is necessary to adjust the lens 120, transmits control signals to the lens controller 130, and/or receives information from the lens controller 130. As such, the control unit 115 may be communicatively coupled to the measuring device 150 (or one or more components thereof), the camera 105, and/or the lens controller 130. In addition, the control unit 115 may contain one or more components for directing the lens controller 130 to adjust one or more adjustable components of the lens 120, such as a lens ring 121 of the lens 120, and/or to receive positional information from the lens controller 130, as described in greater detail herein.

The lens 120 may generally be any optics device that is adjustable for altering the light that enters the camera 105 (e.g., light that contacts a film strip and/or a sensor such that an image is captured). As such, the lens 120 may include one or more optical components for adjusting various aspects of altering the light, including components that focus light, redirect light, block light, and/or the like. In some embodiments, the lens may be adjustable, such as via the lens ring 121 to adjust one or more aspects such as focus, zoom, aperture, and/or the like. For example, the lens ring 121 may be a focus ring for adjusting a focus of the lens, a zoom ring for adjusting a zoom of the lens, an iris ring for adjusting an aperture of the lens, and/or the like. It should be understood that while the term “ring” is used to describe the component that adjusts certain lens components, the present disclosure is not limited to such. Accordingly, other devices that may be used to adjust a focus, a zoom, an aperture, and/or the like of a lens may also be used without departing from the scope of the present disclosure.

The lens controller 130 may be a motorized device (e.g., an actuator) that is coupled to and/or integrated with at least a portion of the lens 120 such that the lens controller 130 can control various movable functions of the lens 120 to effect a change in a zoom, a focus, an aperture, and/or the like. For example, the lens controller 130 may rotate the lens ring 121 to adjust a focus or a zoom. In another example, the lens controller 130 may adjust an iris or diaphragm (not shown) to control an aperture. In some embodiments, the lens controller 130 may be able to determine physical endpoints of adjustment features of the lens 120. In some embodiments, the lens controller 130 may be able to transmit information to the control unit 115, such as state information (e.g., positioning of the lens controller 130 and/or the lens 120), a location of physical end points, and/or the like.

As a result of the adjustments by the lens controller 130, the lens 120 may contain particular parameters such that the light that enters the camera 105 results in an image that is particularly focused, particularly exposed, and/or the like. In some embodiments, the lens controller 130 may be integrated within the lens 120 (e.g., an internal lens controller). In other embodiments, the lens controller 130 may be coupled to an outside portion of the lens 120. While the lens controller 130 may automatically control the lens 120, it should generally be understood that the lens controller 130 may also be configured to allow manual control of the lens 120 as well. For example, a user may manually rotate the lens ring 121 without being hindered by the lens controller 130 and/or damaging the lens controller 130.

The measuring device 150 generally includes a measuring component, such as a component that incorporates laser, radar, sonar, lidar, and/or ultrasonic technology (e.g., a range finder). Other means of measuring distance may also be used without departing from the scope of the present disclosure, such as measuring components that incorporate a wi-fi positioning system or other radio-based distance measuring systems. As such, while the measuring device 150 is described herein as being an infrared (IR) measuring device for purposes of illustration, the present disclosure is not limited to such. The measuring device 150 may include an infrared (IR) emitter 160, an IR receiver 165, interface hardware 170a, 170b (collectively 170), a viewing component 175, and an offset measuring device 195. The measuring device 150 may further include other internal components, as described herein with respect to FIG. 2. The IR emitter 160, the IR receiver 165, the user interface components, and the viewing component 175 are communicatively coupled to one another such that a distance to a target object can be determined, as described in greater detail herein.

The IR emitter 160 is generally any device that is understood to generate and emit an IR signal. In some embodiments, the IR emitter 160 may emit the IR signal in the form of an IR laser beam that is directed in a particular direction and can be reflected off a wide variety of surfaces. The IR emitter 160 is arranged with respect to the measuring device 150 such that when a user aims the measuring device at a target object, the IR emitter 160 emits the IR signal towards the target object.

The IR receiver 165 is generally any device that works in conjunction with the IR emitter 160 to receive the IR signal that is emitted by the IR emitter 160 once it has reflected off an object. That is, the IR signal, when emitted by the IR emitter 160, contains various characteristics that are known. When the signal is received by the IR receiver 165, such characteristics are compared with the known characteristics to determine a difference, which, in turn, can be used to determine a distance to an object that reflected the IR signal. For example, the IR emitter 160 and the IR receiver 165 may function together such that the IR emitter emits a pulse of light towards a target object. The pulse of light is reflected off the target object, and a portion of the light is received by the IR receiver 165. When the light is received by the IR receiver 165, a distance to the target object can be determined. For example, the distance can be determined using a time-of-flight calculation (e.g., embodiments where the measuring device 150 incorporates a time-of-flight camera), as described in greater detail herein. In another example, the distance can be determined by an angle at which the IR receiver 165 receives the reflected light. That is, the angle at which the light is received is dependent on the distance between the target object and the IR receiver 165. The IR receiver 165 can determine the angle, which, in turn, can be used to determine the distance between the target object and the IR receiver 165, as described in greater detail herein. Embodiments where the measuring device 150 incorporates a time-of-flight measuring system may allow for a more accurate distance measurement relative to embodiments where the measuring device 150 incorporates other types of measuring systems because time-of-flight measurements may allow for greater control of laser beam emissions.

In some embodiments, the IR emitter 160 and the IR receiver 165 may be combined into a single IR sensor device. IR sensor devices that are used for determining an object distance should generally be understood, including sensors that determine distance via an angular calculation and sensors that determine distance via time-of-flight calculation. In some embodiments, the IR sensor device may provide an analog signal or one or more digital bits, which can be used to determine the received IR signal characteristics (e.g., the angle at which it was received or the time-of-flight) and the distance to the target object.

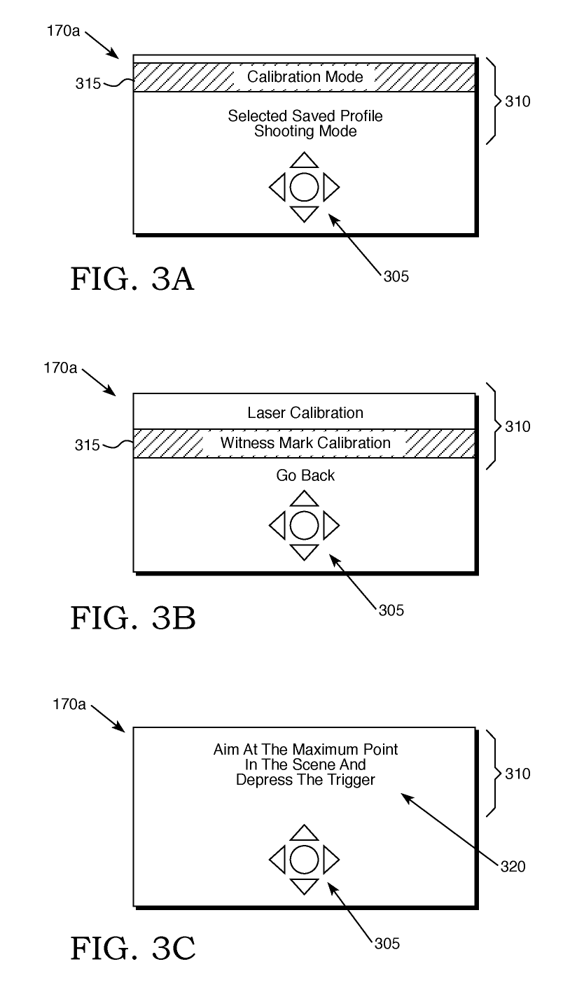

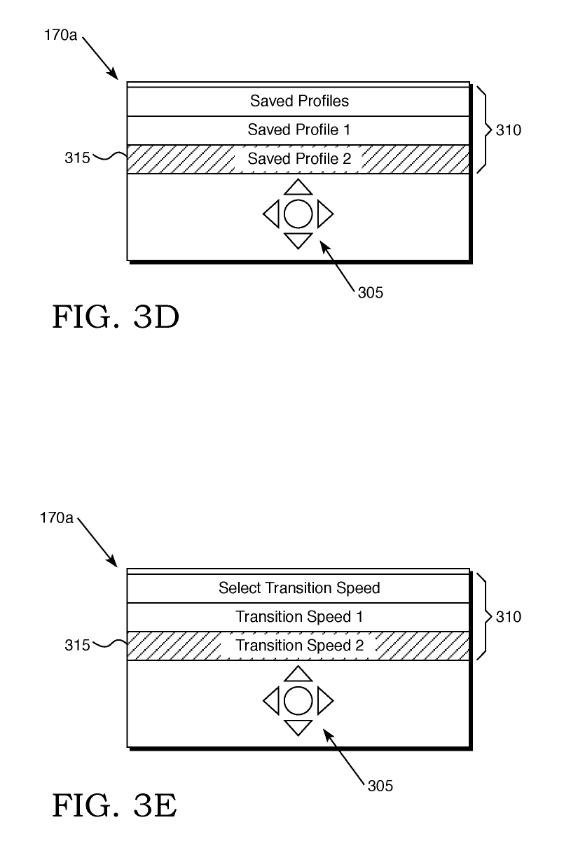

The interface hardware 170 may generally provide an interface between a user and the various components of the measuring device 150 such that the user can direct the measuring device 150 to emit an IR signal, determine a distance to a target object, communicate with one or more components of the camera 105, adjust settings, remotely control the lens 120, and/or the like. For example, the interface hardware 170 may include a user interface display 170a and/or a triggering device 170b. The user interface display 170a may display information in any format, including, but not limited to displaying information in alphanumerical format, displaying images, displaying graphical renderings, and/or the like. Illustrative information that may be displayed on the user interface display 170a is described herein with respect to FIGS. 3A-3E. In some embodiments, the user interface display 170a may be coupled to components for receiving one or more user inputs, including physical inputs such as buttons, knobs, sliders, and/or the like located separate from the user interface display 170a. In some embodiments, the user interface display 170a may be integrated with components for receiving one or more user inputs. For example, the user interface display 170a may be a touchscreen display or the like that can be physically manipulated by a user. Such components, whether integrated with the user interface display 170a or coupled to the user interface display 170a, may allow a user to interact with the measuring device 150 in response to information provided on the user interface display 170a.

The triggering device 170b may be a user interface device that is separate from the user interface display 170a that also receives user inputs. The triggering device 170b may be a button, trigger, or the like that, when depressed, transmits a signal to one or more portions of the measuring device 150, as described in greater detail herein. For example, the triggering device 170b may provide a signal that directs the IR emitter 160 to emit the IR signal (pulse of light) and/or directs the IR receiver 165 to receive the reflected IR signal. In some embodiments, the triggering device 170b may be used to indicate a target object for the purposes of calibration and/or maintaining a focus of the lens, as described herein. For example, a user may continuously depress the triggering device 170b to maintain a continuous focus on a target object or use the triggering device 170b as a means of indicating when to start and stop maintaining a continuous focus on a target object.

The viewing component 175 may be a display, a viewfinder, or the like that allows a user to view objects through the measuring device 150. For example, a user may utilize the viewing component 175 to ensure that the IR signal emitted by the IR emitter 160 is appropriately aimed at a target object. As such, in embodiments where the viewing component 175 is a display, the viewing component 175 may display an image corresponding to a field of view of the measuring device 150 or a component thereof. For example, the measuring device 150 may include an imaging device that is aimed in substantially the same direction as the IR emitter 160 such that a field of view of the imaging device is substantially the same as a field of view of the IR emitter 160. Such an imaging device may be sensitive to the type of radiation emitted by the IR emitter 160 such that it detects the signal emitted by the IR emitter 160 and transmits a corresponding image to the viewing component 175 for the user to view. In embodiments where the viewing component 175 is a viewfinder (e.g., an optical viewfinder), such a viewfinder may be optically aligned with the IR emitter 160 such that a user using the viewing component 175 can see an area that is within the field of view of the IR emitter 160. In addition, the viewfinder may include one or more filters, lenses, and/or other optical components such that the user can see the radiation that is emitted from the IR emitter 160. That is, the viewing component 175 may allow a user to see where the signal emitted from the IR emitter 160 is aimed, so as to ensure that the signal is aimed at a target object (e.g., a dot or the like may appear on the target object when viewed through the viewing component 175). Because the signal may otherwise be invisible to the naked eye, use of the viewing component 175 may assist the user in locating the signal. In some embodiments, the viewing component 175 may provide information regarding the measuring device 150, the camera 105, various components of either of the foregoing, or the system 100 as a hole. For example, the viewing component 175 may provide system state information such as whether a communication link between the camera 105 and the measuring device 150 has been established, to provide error conditions (e.g., lens is not focusing), and/or the like.

The offset measuring device 195 may be a device that can be used to determine an offset between the measuring device 150 and a focal plane of the camera 105 such that an accurate distance measurement between a target object and the camera 105 can be determined, as described in greater detail herein. In some embodiments, the offset measuring device 195 may include a component for determining a distance between the measuring device 150 (or a portion thereof) and the camera 105 (or a portion thereof), as well as a relative positioning between the measuring device 150 (or a portion thereof) and the camera 105 (or a portion thereof). For example, the offset measuring device 195 may include a component for determining a distance between the IR receiver 165 and the focal plane of the camera 105 and for determining a relative positioning between the IR receiver 165 and the focal plane of the camera. Such a component may include, for example, a retractable cable or the like that allows the offset measuring device 195 to be physically coupled to the camera 105 (or a portion thereof). The component may further include sensors (e.g., Hall effect sensors and/or the like) that can accurately determine a distance based on a distance the retractable cable extends and determine a relative positioning based on an angle created between the retractable cable and a surface of the offset measuring device 195. The offset measuring device 195 may further be able to provide data (e.g., distance data and/or relative positioning data) for the purposes of determining an offset, as described in greater detail herein. It should be understood that the offset measuring device 195 shown and described herein is merely illustrative. As such, any device that can be used to provide distance and/or relative positioning between the camera 105 and the measuring device 150 may be used without departing from the scope of the present disclosure.

FIG. 2 depicts a block diagram of illustrative internal hardware in the camera 105 and the measuring device 150, respectively. While FIG. 2 depicts the various components of the camera 105 as being separate and distinct from the various components of the measuring device 150 and vice versa, it should be understood that this is only illustrative. That is, in some embodiments, the camera 105 and the measuring device 150 may share certain components described herein without departing from the scope of the present disclosure.

As illustrated in FIG. 2, the camera 105 may include a processor 118, input/output hardware 117, and interface hardware 116 located within the control unit 115; a data storage component 140 containing preferences data 141, lens data 142, device data 143, and/or presets data 144; a non-transitory memory component 125; and the lens controller 130. The memory component 125 may be configured as a volatile and/or a nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 125 may be configured to store various processing logic, such as operating logic 126, imaging logic 127, and/or focusing logic 128 (each of which may be embodied as a computer program, firmware, or hardware, as an example). A local interface 110 is also included in FIG. 2 and may be implemented as a bus or other interface to facilitate communication among the components of the camera 105.

The processor 118 may include any processing component configured to receive and execute instructions (such as from the data storage component 140 and/or the memory component 125). The input/output hardware 117 may include a monitor, keyboard, mouse, printer, camera, microphone, speaker, touch-screen, and/or other device for receiving, sending, and/or presenting data. The interface hardware 116 may include any wired or wireless networking hardware, such as a modem, LAN port, wireless fidelity (Wi-Fi) card, WiMax card, mobile communications hardware, and/or other hardware for communicating with other networks and/or devices, particularly with the measuring device 150, as described herein.

It should be understood that the data storage component 140 may reside local to and/or remote from the camera 105 and may be configured to store one or more pieces of data and selectively provide access to the one or more pieces of data. As illustrated in FIG. 2, the data storage component 140 may store preferences data 141, lens data 142, device data 143, and/or presets data 144. The preferences data 141 may generally be data related to various user preferences with respect to the camera 105. For example, a user may have stored preferences with respect to camera settings, image sensor sensitivity, and/or the like that are stored as part of the preferences data 141. The lens data 142 may include information regarding one or more lenses that are coupled to the camera 105, such as, for example, brand, model number, minimum magnification, maximum magnification, minimum focal length, maximum focal length, minimum f-stop (focal ratio), maximum f-stop, maximum aperture size, minimum aperture size, special purpose information (e.g., macro lens, zoom lens, fisheye lens, stereoscopic lens, soft focus lens, or the like), number of lens elements, mount compatibility, and/or the like. The device data 143 may include information regarding various device settings that may be accessible and/or modifiable by the measuring device 150 and/or a user (e.g., device remote control settings or the like). Presets data 144 may include lens-specific presets that can be stored by a user, such as particular focus ring or zoom ring positioning for particular target object focus, and/or the like.

Included in the memory component 125 are the operating logic 126, the imaging logic 127, and/or the focusing logic 128. The operating logic 126 may include an operating system and/or other software for managing components of the camera 105. The imaging logic 127 may direct the camera 105 and/or one or more components thereof to obtain images (including moving images). The focusing logic may direct the camera 105 and/or one or more components thereof (such as the lens controller 130) to control movement of the lens 120 for the purposes of focusing, zooming, and/or the like, as described herein.

The lens controller 130 may include various components for controlling movement of the lens 120 for the purposes of focusing, zooming, and/or the like. As such, the lens controller 130 may include a zoom controller 132 that is capable of adjusting a zoom of the lens 120. For example, the zoom controller 132 may include a motor or the like that is particularly configured to rotate a zoom ring on the lens 120 to effect control of the zoom. The lens controller 130 may further include a focus controller 134 that is capable of adjusting the focus of the lens 120. For example, the focus controller 134 may include a motor or the like that is particularly configured to rotate a focus ring on the lens 120 to effect control of the focus. In some embodiments, the focus controller 134 and the zoom controller 132 may be a single element capable of controlling both the focus and the zoom of the lens 120 (e.g., the lens ring 121). In addition, the lens controller 130 may include other components not specifically described herein for particularly controlling other aspects of the lens 120, such as a device for controlling an iris of the lens 120 or the like.

As also illustrated in FIG. 2, the measuring device 150 may include a processor 158, input/output hardware 157, interface hardware 170, a data storage component 180 (which may contain preferences data 181, calibration data 182, device data 183, presets data 184, and/or measurement data 185), a non-transitory memory component 190, the IR emitter 160, and the IR receiver 165. The memory component 190 may be configured as a volatile and/or a nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 190 may be configured to store various processing logic, such as operating logic 191, measurement logic 192, and/or focusing logic 193 (each of which may be embodied as a computer program, firmware, or hardware, as an example). A local interface 155 is also included in FIG. 2 and may be implemented as a bus or other interface to facilitate communication among the components of the measuring device 150.

The processor 158 may include any processing component configured to receive and execute instructions (such as from the data storage component 180 and/or the memory component 190). The input/output hardware 157 may include a monitor, keyboard, mouse, printer, camera, microphone, speaker, touch-screen, and/or other device for receiving, sending, and/or presenting data. In some embodiments, the input/output hardware may include the interface hardware 170 (FIG. 1) described herein. The interface hardware 170 may include any wired or wireless networking hardware, such as a modem, LAN port, wireless fidelity (Wi-Fi) card, WiMax card, mobile communications hardware, and/or other hardware for communicating with other networks and/or devices, particularly with the camera 105, as described herein.

It should be understood that the data storage component 180 may reside local to and/or remote from the measuring device 150 and may be configured to store one or more pieces of data and selectively provide access to the one or more pieces of data. As illustrated in FIG. 2, the data storage component 180 may store preferences data 181, calibration data 182, device data 183, presets data 184, and/or profile data 185. The preferences data 181 may be data related to various user preferences with respect to the measuring device 150. For example, a user may have stored preferences with respect to measurement settings, IR sensor sensitivity, and/or the like that are stored as part of the preferences data 181. The calibration data 182 may generally be data relating to calibration of a particular lens with distance data obtained from the measuring device 150 or manually entered from distances inscribed on the lens, including previously stored calibration and/or measurement information, as described in greater detail herein. The device data 183 may include information regarding various device settings that may be accessible and/or modifiable by a user (e.g., device remote control settings or the like). The presets data 184 may be similar to that of the presets data 144 present in the data storage component 140 of the camera 105 in that the presets data 184 may also include lens-specific presets that can be stored by a user, such as particular focus ring or zoom ring positioning for particular target object focus, and/or the like. The presets data 184 may also include particular lens controller parameters to ensure lens presets, as described in greater detail herein. The profile data 185 may generally include information regarding measurement profiles that may be saved by a user of the measurement device, as described in greater detail herein.

Included in the memory component 190 are the operating logic 191, the measurement logic 192, and/or the focusing logic 193. The operating logic 191 may include an operating system and/or other software for managing components of the measuring device 150. The measurement logic 192 may direct the measuring device 150 and/or one or more components thereof to obtain distance measurements to one or more target objects in response to a user input. The focusing logic 193 may direct the measuring device 150 and/or one or more components thereof to determine a particular focus position of a lens that correlates with obtained measurement information, as described in greater detail herein.

The offset measuring device 195 may also be communicatively coupled to the local interface 155 such that data can be transmitted to and/or from the offset measuring device 195. More specifically, data that can be used to determine an offset may be transmitted from the offset measuring device 195, such as distance data and/or relative positioning data, as described in greater detail herein.

It should be understood that the components illustrated in FIG. 2 are merely illustrative and are not intended to limit the scope of this disclosure. More specifically, while the components in FIG. 2 are illustrated as residing within the camera 105 and/or the measuring device 150, this is a nonlimiting example. In some embodiments, one or more of the components may reside external to the camera 105 and/or the measuring device 150.

As previously described herein, the user interface display 170a may display various information to a user. For example, as shown in FIGS. 3A-3E, the user interface display 170a may include one or more input devices 305 and one or more selectable menu items 310. One of the selectable menu items 310 may be highlighted, indicating a selected menu item 315. Upon selection, the user interface display 170a may display additional menu items, take an action, store data, and/or the like. For example, as shown in FIG. 3A, “calibration mode” is the selected menu item 315. When it is selected, a submenu may display, as shown in FIG. 3B. In some embodiments, the user may select one of the submenu options, such as “laser calibration” or “witness mark calibration” as the selected menu item 315. Upon selection of a menu item or a submenu item, the user interface display 170a may provide instructions, additional menu items, images, guides, and/or the like. For example, as shown in FIG. 3C, the user interface display 170a may display one or more directions 320, such as to “aim at the maximum point in the scene and depress the trigger” to begin calibration when the user enters a calibration mode. Other user interface displays are depicted in FIGS. 3D and 3E, including an interface for saving calibration profiles and an interface for adjusting a transition speed. It should be understood that the menu items depicted in FIGS. 3A-3E are merely provided for illustrative purposes only, and other menu items (as well as the specific arrangement and design thereof) are included within the scope of the present disclosure.

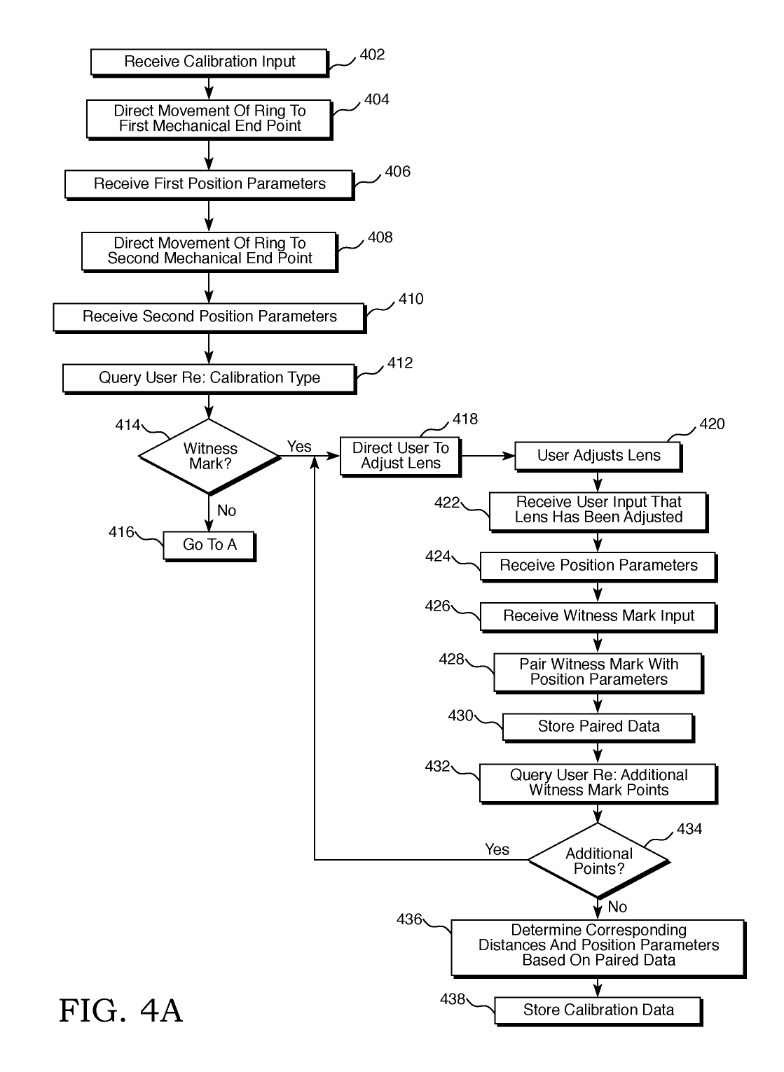

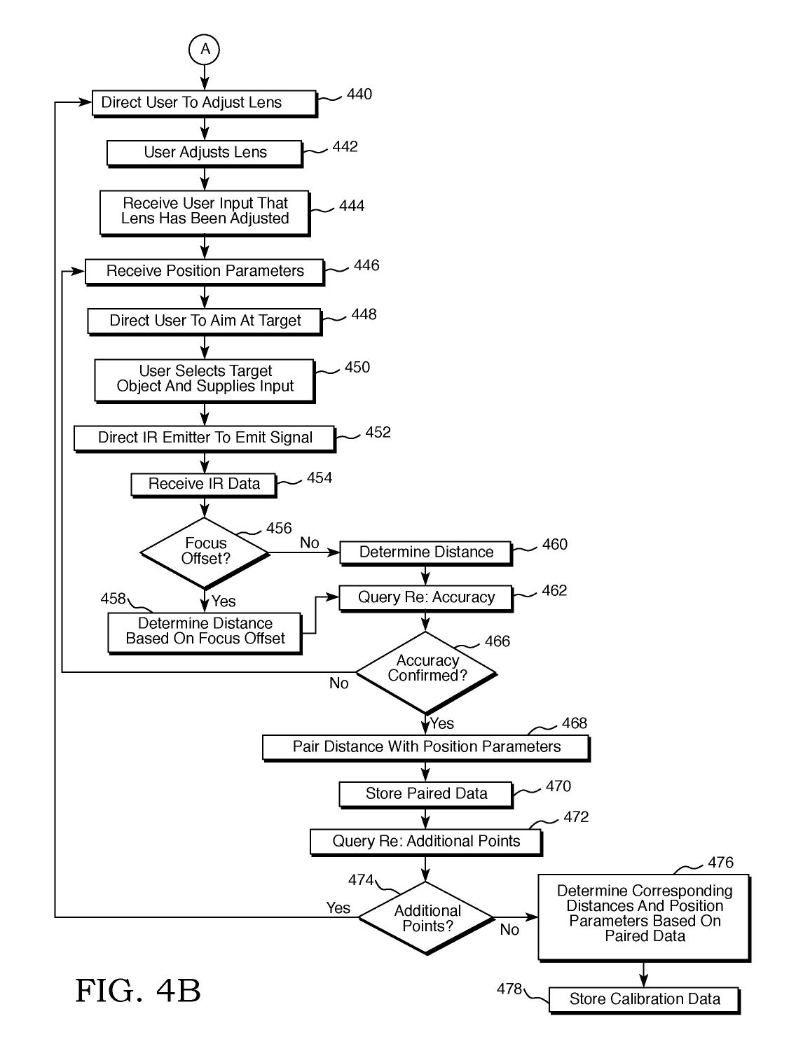

FIGS. 4A and 4B depict flow diagrams relating to illustrative methods of calibrating the measuring device so that it can be used with a particular lens according to one or more embodiments. The various steps described herein with respect to FIGS. 4A and 4B may generally be completed by the measuring device 150 and/or one or more components thereof, as described with respect to FIGS. 1 and 2. However, it should be understood that some steps may be completed by the camera 105, the control unit 115, the lens controller 130, or a combination of any of the foregoing (including one or more components of the camera 105 and/or the measuring device 150).

At step 402, a calibration input may be received. That is, an input corresponding to a command to begin a calibration process may be received. For example, a user may select “calibration mode” on the user interface display of the measuring device to transmit a calibration input.

At step 404, the lens controller may be directed to move the lens ring to a first mechanical end point of the lens. That is, the lens controller may receive a signal from the control unit and may rotate the lens ring in a first direction until the lens ring cannot physically move any further (mechanical end point) in response to the signal. For example, the lens ring may be moved in a clockwise direction or a counterclockwise direction until the first mechanical end point is reached. Alternatively, in some embodiments, a user may manually move the lens ring to the first mechanical end point or a point at which the user desires to indicate as being an end point. For example, the user may desire to indicate the end point as being a particular distance marker that appears on the lens ring. In another example, the user may move the lens ring to an upper focus limit or a lower focus limit on the lens ring and indicating such a focus limit as being an end point.

At step 406, first position parameters may be transmitted by the lens controller. The first position parameters may generally indicate a positioning of the lens controller at the first mechanical end point of the lens ring. That is, the lens controller may transmit data that corresponds to how much (e.g., a distance from a known point) the lens controller moved in a particular direction to reach the first mechanical end point. Such position parameters may be transmitted to the control unit, the camera (or any component thereof), and/or the measuring device (or any component thereof). In some embodiments, the first position parameters may be stored as data for future access. For example, the first position parameters may be stored as lens data and/or calibration data, as described herein.

At step 408, the lens controller may be directed to move the lens ring to a second mechanical end point of the lens. That is, the lens controller may receive another signal from the control unit and may rotate the lens ring in a second direction until the lens ring cannot physically move any further (mechanical end point) in response to the signal. For example, the lens ring may be moved in a clockwise direction or a counterclockwise direction (e.g., the direction may be opposite to the first direction) until the second mechanical end point is reached. Alternatively, in some embodiments, a user may manually move the lens ring to the second mechanical end point or a point at which the user desires to indicate as being an end point. For example, the user may desire to indicate the end point as being a particular distance marker that appears on the lens ring. In another example, the user may move the lens ring to an upper focus limit or a lower focus limit on the lens ring and indicating such a focus limit as being an end point.

At step 410, second position parameters may be transmitted by the lens controller. The second position parameters may generally indicate a positioning of the lens controller at the second mechanical end point of the lens ring. That is, the lens controller may transmit data that corresponds to how much (e.g., a distance from a known point, such as the first position parameters or the like) the lens controller moved in a particular direction to reach the second mechanical end point. Such position parameters may be transmitted to the control unit, the camera (or any component thereof), and/or the measuring device (or any component thereof). In some embodiments, the second position parameters may be stored as data for future access. For example, the second position parameters may be stored as lens data and/or calibration data, as described herein.

At step 412, a query may be provided as to the type of calibration that is desired. While FIG. 4A indicates that the query may be presented to the user, this is a nonlimiting example. In some embodiments, no query may be provided. In other embodiments, the query may be provided to an external computing device or the like. In some embodiments, the query may ask whether laser calibration is desired, or whether a witness mark calibration is desired. For example, a user may desire a witness mark calibration to calibrate the lens according to manufacturer-provided witness marks that are indicated on the lens or documentation accompanying a lens. It should be understood that witness mark calibrations may not necessarily result in a desired or accurate focus of the lens. In another example, a user may desire a laser calibration where the lens focus, zoom, and/or the like is automatically determined for each of a plurality of particular distance measurements by using the measuring device, as described in greater detail herein. It should be understood that while the phrase “laser calibration” is used herein, such a calibration is not limited to such. For example, in embodiments where the measuring device incorporates other types of distance measurement (such as ultrasonic measurement), the calibration may be more appropriately referred to as an “ultrasonic calibration” instead of a “laser calibration”.

As a result of the query, an input indicative of whether a witness mark calibration is desired may be received and a corresponding determination may be completed at step 414. If the determination is that a calibration other than a witness mark calibration (e.g., a laser calibration or the like) is desired, the process may proceed to the various steps described with respect to FIG. 4B herein at step 416. If the determination is that a witness mark calibration is desired, a direction may be provided to manually adjust the lens at step 418. For example, a command or the like may be provided to a user to direct the user to manually adjust the lens to a desired positioning. The command may be provided, for example, via the user interface display, via the viewing component, and/or the like.

At step 420, the user may manually adjust one or more lens settings to achieve a desired lens positioning. For example, the user may manually adjust the focus ring of the lens to achieve a desired focus (e.g., by aligning the lens ring with a particular marker), adjust a zoom ring (or similar component) to achieve a desired zoom, adjust an iris control (or similar component) to achieve a particular aperture, and/or the like. Once the user has manually adjusted the lens to his/her desired settings, the user may provide an input indicating such. Accordingly, at step 422, an input that indicates that the lens has been adjusted may be received. For example, the user may provide an input via the user interface display indicating that the lens has been manually adjusted.

At step 424, position parameters may be received from the lens controller. The position parameters generally refer to the positioning of various lens components that are adjustable to change a focus, a zoom, an aperture size, and/or the like. For example, the position parameters may indicate a positioning of the lens ring on the lens relative to one or more known points, such as the first mechanical end point, the second mechanical end point, and/or the like. Such position parameters may be obtainable by receiving information from the lens controller that indicates its positioning after manual movement of the lens components. For example, the lens controller may have an initial position of the various lens adjustment components (e.g., one of the mechanical end points), and movement of such components may cause the lens controller to detect and measure its own movement such that the position parameter can be determined from the initial position and the measured amount of movement.

At step 426, a witness mark input may be received. That is, an input that corresponds to the witness mark at which the camera lens is adjusted may be received such that the predetermined focus distance is provided. In some embodiments, the input may be provided via the interface hardware. For example, a user may input a witness mark measurement that corresponds to the location of the lens adjustment via the interface hardware by entering a distance measurement. The inputted witness mark may be paired with the received position parameters at step 428, and may be stored as paired data at step 430. In some embodiments, the paired data may be stored in the calibration data portion of the data storage or in the profile data portion of the data storage.

At step 432, a query may be provided as to whether additional witness mark points are to be included and/or a determination may be made as to whether additional points are needed at step 434. For example, a user may be queried as to whether additional witness mark points are needed, and the determination may be made solely based on the user's response to the query. If additional calibration points are necessary (e.g., an affirmative response to the query is received), the process may repeat at step 418.

If additional calibration points are not necessary (e.g., an affirmative response to the query is not received), various additional corresponding distances and position parameters may be determined based on the paired data at step 436. That is, in some embodiments, the generated or appended lookup table may be further populated with corresponding information based on the obtained information described above such that the lookup table includes corresponding distances and lens position parameters for each possible lens position. If additional corresponding points are determined, such points may be stored as calibration data at step 438. It should be understood that steps 436 and 438 may also be completed during an automatic focus operation, as described in greater detail herein. Completion of such steps during automatic focus operation may avoid a need for large file sizes to store data corresponding to other distances and lens position parameters.

FIG. 4B depicts an illustrative method of conducting a calibration process, such as a laser calibration, as described herein. At step 440, instructions may be provided to adjust the lens. More specifically, a user may be directed to adjust the lens, such as by moving the lens ring (e.g., focus ring, zoom ring, aperture control, and/or the like) to a first location. Accordingly, at step 442, the user may adjust the lens to achieve a desired lens setting, such as, for example, a desired focus, a desired zoom, a desired aperture setting, and/or the like. The user may achieve the desired lens setting, for example, by moving the lens ring in a first direction (e.g., clockwise or counterclockwise) to a particular location. Once the user has adjusted the lens, an input may be received at step 444. More specifically, the input may be an indication that the user has adjusted the lens. The input may be provided, for example, via the input hardware described herein.

The position parameters may be received from the lens controller at step 446. As previously described herein, the position parameters generally correspond to signals received from the lens controller regarding the state/positioning of the lens controller (and thus the lens) relative to a particular point, such as, for example, a mechanical end point of the lens. The information provided by the lens controller can be used to determine one or more measurements or other data that is indicative of the lens positioning.

At step 448, instructions for aiming the measuring device at a target object or location may be provided. In some embodiments, the target object or location may be a maximum or minimum distance point. The minimum or maximum distance point may be, for example, a point in the scene that is observed by the user as being in focus when the lens ring is moved to a location that is at or near one of the mechanical end points. In other embodiments, the target object or location may be selected by the user as being a target object or location that appears to be in focus when viewed through the lens.

At step 450, the measuring device may be aimed at the target object and an input may be provided (e.g., by a user depressing the triggering device). In embodiments where the measuring device is an IR measuring device as described herein, the measuring device be directed to emit an IR signal at step 452. It should be understood that the measuring device may emit other signals, such as ultrasonic signals or the like, for the purposes of distance measurement.

At step 454, data corresponding to the reflected and detected IR signal may be received. For example, infrared data may be received from the measuring device and/or one or more components thereof (e.g., from the IR receiver). The infrared data may be raw data that can be used to determine a distance to the target object, or may be measurement data that provides a measurement to the target object. In embodiments where the received data is raw data, the data may be used to determine the distance to the target object, as described in greater detail herein.

Before a distance can be determined, a first determination may be completed at step 456 as to whether an offset must be calculated. That is, a determination may be made as to whether the measuring device is located within the same focal plane as an imaging component of the camera. If the measuring device is not located within the same focal plane as the imaging component, the received data may be used in a focus offset calculation to determine the distance to the target object at step 458, as described in greater detail herein. If the measuring device is located within the same focal plane as the imaging component, the received data may be used to determine the distance at step 460 without the need to determine an offset.

Calculating the distance without an offset according to step 460 may be completed in a plurality of different ways. For example, in some embodiments, the distance may be calculated using a Time-of-Flight (TOF) calculation. In other embodiments, the distance may be calculated using Lambert's cosine law.

A TOF calculation generally includes determining the distance to the target object by calculating the amount of time it takes for a pulse of light to be emitted, reflected, and received, since the speed of light is known to travel at about 300,000,000 meters per second (m/s). As such, the distance D to the target object using a general TOF calculation may be determined according to Equation (1):

$${t}_{D} = 2 ( \frac{D}{c} ) \qquad ( 1 )$$

where t_{D} is the amount of time it takes for the light to travel (from emission to reception) and c is the speed of light (300,000,000 m/s).

Equation (1) may be modified to account for the constant beam of light that is emitted by the IR emitter. For example, the IR emitter may use two switches (G1 and G2) and two memory elements (S1 and S2). The switches may be controlled by a pulse with the same length as the light pulse, where the control signal of switch G2 is delayed by exactly the pulse width. Depending on the delay, only a portion of the light pulse is sampled through G1 in S1, whereas the other portion is stored in S2. Depending on the distance, the ratio between S1 and S2 changes. Because only small amounts of light hit the sensor within 50 ns, several thousand pulses may be emitted at a repetition rate tR and sensed, thus increasing a signal-to-noise ratio.

After the exposure, the pixel is read out and the following stages measure the signals S1 and S2. As the length of the light pulse is defined, the distance can be calculated with Equation (2):

$$D = \frac{1}{2} {ct}_{0} \frac{S 2}{S 1 + S 2} \qquad ( 2 )$$

where D is the distance, c is the speed of light, and t0 is the pulse width. Time of flight calculations that account for other variables should generally be understood, and are included within the scope of the present disclosure.

Lambert's cosine law states that the radiant intensity of the received IR signal is directly proportional to the cosine of the angle θ between the direction of the incident light and the surface normal. For example, such a determination may be made by calculating the angle at which the IR signal is received. Equation (3) below can be used to model the IR signal output s(x, θ) as a function of the distance x and the angle of incidence θ with a surface of a target object:

$$s ( x , θ ) = \frac{α}{{x}^{2}} cos θ + β \qquad ( 3 )$$

where α and β are model parameters. For example, α may be a radiant intensity of the IR emitter, a spectral sensitivity of the IR receiver, an amplifier gain, and a reflectivity coefficient of the target object. The radiant intensity of the IR emitter, the spectral sensitivity of the IR receiver, and the amplifier gain may be constant, but reflectivity coefficient may be dependent on the target. Thus, α can be expressed as the product of two parameters, α₀ and αᵢ, where α₀ is constant for all measurements and expressed in V m², and αᵢ is a dimensionless reflectivity coefficient that can vary from 0 (black target) to 1 (white target). Such a parameter can be expressed according to Equation (4):

α=α₀αᵢ (4)

β equals the amplifier's offset plus ambient light effect, and can be obtained by taking a first reading without IR emission (e.g., before the IR transmitter transmits an IR signal). A second reading may be taken after the IR transmits an IR signal, and the signal without the offset β is obtained by subtracting the first reading from the second reading. As such, Equation (1) can be rewritten as Equation (5) below:

$$y ( x , θ ) = s ( x , θ - β ) = \frac{α}{{x}^{2}} cos θ \qquad ( 5 )$$

As described hereinabove, in some embodiments, the measuring device may not be located at the same distance from the target object as the imaging device of the camera (e.g., the measuring device and the imaging device of the camera may not be located in the same plane). For example, the measuring device may be located a particular distance behind the lens, such that the distance between the lens and the target object is shorter than the distance between the measuring device and the target object. In another example, the measuring device may be located on a mount or the like that is located to the left or to the right of the lens. Without an offset, the measuring device would be required to always be located within a film plane of the camera and must further be as close as possible to the optical axis the lens. If an offset is not accounted for, and the measuring device and camera/lens are not aligned as described above, the resulting shot may be out of focus. As such, an offset may be automatically calculated or user set, where the offset accounts for the differences between the measured distance between the target object and the measuring device and the distance between the lens and the target object.

A method of determining an offset may use a continuously variable input device so that a user of the measuring device is able to adjust focus offset based on live image feedback received from the motion camera. In this method, an operator of the measuring device may be positioned wherever desired or necessary for purposes of operating the camera. With no offset set, the operator may point the measuring device at an artifact in the camera's field of view. Then, using a continuously variable input located on the measuring device, the operator may adjust the offset until the artifact that is viewed on a camera screen comes into focus. This method may eliminate a need for manual measurement of the distance between the measuring device and the film-plane of the camera. It should be understood that this method may be particularly suited for instances where the measuring device and the camera do not move relative to one another during a scene capture.

Automatic calculation of an offset necessarily requires that the distance and relative locations of the lens and the measuring device be known. As such, calculation of the offset may necessitate use of a draw-wire sensor or the like that is coupled between the measuring device and the camera (e.g., the offset measuring device described herein). More specifically, the draw-wire may be attached to the camera at the film plane and to the measuring device. The draw wire may be any draw wire or similar device that can be used to continuously determine a relative distance and location between two objects. Moreover, it should be understood that a draw-wire sensor coupled to the draw wire takes up slack in the draw wire, so the measuring device and the camera can move freely with respect to one another. This sensor, combined with another sensor measuring the relative angle of the measuring device to the camera, can be used to calculate offset using Equation (6):

D_{C}={square root over ((D_{L} sin θ_{LC})²+(D_{LC}−D_{L} sin(90−θ_{LC}))²)} (6)

where D_{C} is a distance between the target object and the focal plane along the optical axis of the lens, D_{L} is the distance between the measuring device and the target object, θ_{LC} is the angle in degrees of the measuring device relative to the lens and the target object, and D_{LC} is the distance between the lens and the measuring device. Equation (6) assumes θ_{LC} is in the plane of the measuring device, camera, and focus target. That is, the measuring device's local axis that is perpendicular to the D_{L} axis is in the same plane as the triangle formed by the measuring device, camera, and target. If the measuring device is tilted about the D_{L} axis such that the above isn't true, additional calculation and data may be necessary to apply the appropriate transformations necessary to calculate the correct offset.

At step 462, a query may be provided to verify the accuracy of the distance measurement. For example, the query may be provided to a user, where the query asks the user to verify that the target object that was selected is in focus through the lens. Accordingly, a determination of whether the accuracy has been confirmed is determined at step 466. If the accuracy is not confirmed, the process may return to step 446 for correction.

Once the distance between the focal plane of the camera and the target object (and the offset between the focal plane of the camera and the measuring device (if any)) is determined and the accuracy is confirmed, the distance measurement may be paired with the position parameters in step 468 to obtain paired data. That is, a lookup table or the like may be generated or appended such that the distance measurement and the position parameters can be correlated with one another for future access and use. The paired data may then be stored at step 470. The paired data may be stored, for example, as part of the calibration data of the data storage device associated with the measuring device, as described in greater detail herein.

At step 472, a query may be provided as to whether additional mapped points are desired/necessary and a determination may be made at step 474 as to whether additional mapped points are desired/necessary. For example, a user may wish to map additional points to ensure particular target objects in a scene are focused correctly. If additional points are not desired/necessary, corresponding distances and position parameters for points between the first and second end points based on the pairing data may be determined at step 476. That is, one or more additional points between the first end point and the second end point may automatically be determined, and a corresponding distance measurement may be recorded. Such an automatic determination may be completed by plotting the corresponding end points and corresponding distance measurements, interpolating points, such as, for example, drawing a line between the two plotted points (e.g., linear interpolation), using Bezier or quadratic curve type interpolation, and/or the like, and automatically determining what a corresponding location parameter for a given distance measurement would be based on its location on the line. The resulting data may be stored as calibration data 478 for future access, as described herein. It should be understood that, in some embodiments, interpolation of distance to focus ring position between mapped points as described above with respect to step 476 may be completed during an autofocus operation instead of during calibration without departing from the scope of the present disclosure.

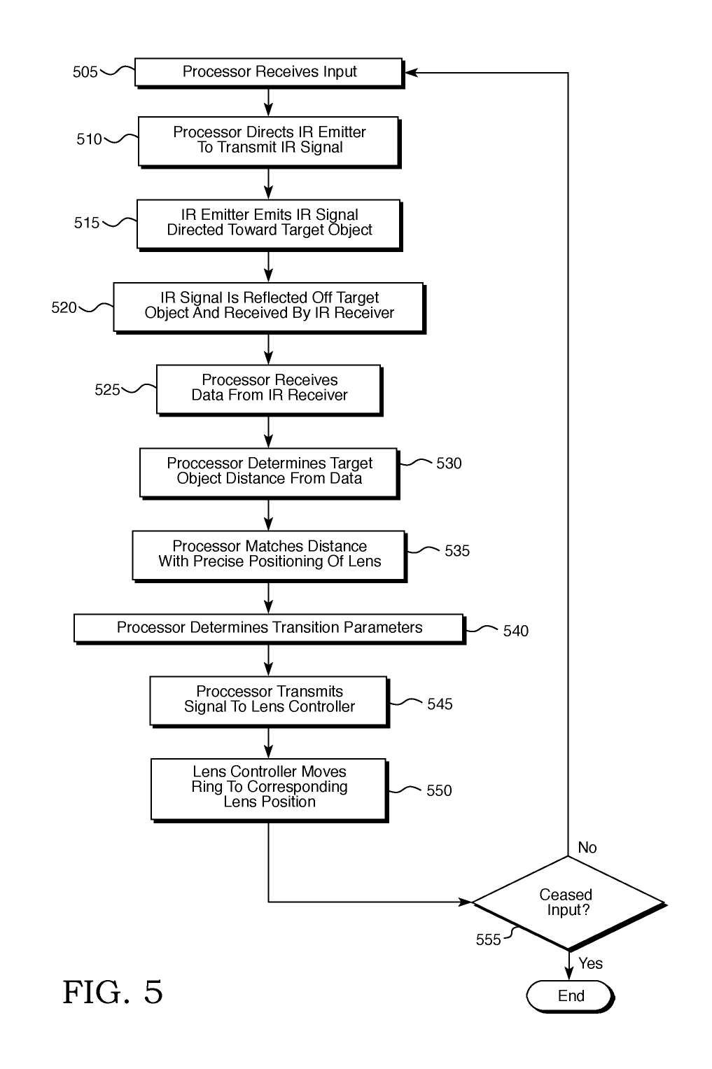

FIG. 5 depicts a flow diagram of an illustrative method of automatically adjusting the focus of a motion camera lens based on distance measurements determined by the measuring device. In some embodiments, the automatic adjustment of the focus may occur continuously so as to maintain a continuous focus on a particular target object, even as the target object moves relative to the camera/lens.

At step 505, the processor of the measuring device may receive an input. The input may be, for example, a user input that corresponds to a user's desire to begin maintaining a focus on a target object. Alternatively, the input may be a command that is received to begin automatic continuous focus. In some embodiments, the input may be received when the user depresses the triggering device of the measuring device. In some embodiments, it may be necessary for the user to continuously depress the triggering device to ensure that the automatic focus on the target object is continuous for as long as the triggering device is depressed.

At step 510, the processor may direct the IR emitter to transmit an IR signal, and the IR emitter may emit the IR signal that is directed toward the target object at step 515. The reflected IR signal is received at step 520, and the corresponding data is received by the processor at step 525. As previously described herein, the corresponding data may be raw data or distance measurement data. If the data is raw data, the distance to the target object may be determined at step 530. Such a determination of the distance to the target object may be completed as described in greater detail hereinabove with respect to FIG. 4A. Moreover, such a determination of the distance to the target object may be completed based on a calculated offset, as also described in greater detail herein with respect to FIG. 4B.

At step 535, the processor may access the lookup table and/or other related data that was obtained from calibration and determine the necessary precise positioning of the lens therefrom. That is, the processor may determine lens ring positioning parameters that correspond to the distance measurement. In embodiments where interpolation is completed during the calibration described with respect to FIGS. 4A and 4B, the lookup table may include a plurality of different points and corresponding distances. In other embodiments, matching the distance with the lens positioning according to step 535 may include interpolating corresponding points based on the data that is provided in the lookup table, as described in greater detail herein. In addition to determining the lens positioning parameters, the processor may also determine the transition parameters at step 540. That is, if a particular transition speed between focus points has been established, such a transition speed may be provided via the transition parameters.

The processor may then transmit a signal to the lens controller at step 545. The signal provides the lens ring position parameters and the transition parameters (if any). Upon receipt of the lens ring position parameters and/or the transition parameters, the lens controller may move the lens ring to the location specified by the parameters at step 550. The lens controller may further move the lens ring at a particular speed or the like based on any transition parameters that are also received. Such a lens ring positioning may be maintained for as long as the signal received from the processor corresponds to such a positioning. As such, a determination may be made at step 555 as to whether the input indicating an automatic focusing session has ceased. That is, if filming is complete and a focus is no longer needed, the user may release the triggering device or otherwise provide a termination signal indicating a termination and the process may end. If input has not been received (e.g., the user continues to depress the triggering device and/or fails to transmit a termination signal), the process may repeat at step 505. Otherwise, the process may end.

It should now be understood that the systems described herein continuously and automatically direct the focus of a lens coupled to a motion camera such that a target object remains in focus even as it moves relative to the motion camera. In addition, the methods described herein may be used for calibrating the systems (or portions thereof) to a particular lens and/or methods for continuously and automatically directing the focus of the lens. The systems described herein generally include the motion camera and a measuring device. The camera includes a control unit and a lens controller. In some embodiments, the camera may also include a lens. The measuring device includes an IR emitter, an IR receiver, a user interface, and includes stated sensors required to automatically calculate focus offset. The measuring device is communicably coupled to the camera.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A measuring device comprising:
one or more infrared components that generate and receive one or more infrared signals for measuring a distance;
a processing device; and
a non-transitory, processor-readable storage medium, the non-transitory, processor-readable storage medium comprising one or more programming instructions that, when executed, cause the processing device to:
continuously obtain data from the one or more infrared components, wherein the data corresponds to a distance between a target object and a lens coupled to a motion camera,
determine one or more position parameters of the lens that corresponds to a focused image of the target object, and
transmit the one or more position parameters to a lens controller, thereby causing the lens controller to adjust a positioning of the lens to correspond to the position parameters.

2. The measuring device of claim 1, wherein the one or more infrared components comprise an infrared emitter and an infrared receiver, wherein the infrared emitter emits the one or more infrared signals toward the target object and the infrared receiver receives the one or more infrared signals that have reflected off the target object.

3. The measuring device of claim 1, wherein the non-transitory, processor-readable storage medium further comprises one or more programming instructions that, when executed, cause the processing device to:
determine an offset distance between the measuring device and the lens.

4. The measuring device of claim 3, wherein the one or more programming instructions that, when executed, cause the processing device to determine the one or more position parameters of the lens further cause the processing device to determine the one or more position parameters of the lens based on the offset distance between the measuring device and the lens.

5. The measuring device of claim 1, wherein the one or more programming instructions that, when executed, cause the processing device to determine the one or more position parameters of the lens that corresponds to a focused image of the target object further cause the processing device to:
obtain calibration data that is specific to the lens; and
determine the one or more position parameters of the lens based on the calibration data.

6. The measuring device of claim 1, further comprising a user interface display for providing information and receiving one or more inputs.

7. The measuring device of claim 1, further comprising a user interface comprising a triggering device.

8. The measuring device of claim 7, wherein the one or more programming instructions that, when executed, cause the processing device to continuously obtain data from the one or more infrared components occurs only when a signal is received from the triggering device.

9. The measuring device of claim 1, further comprising a viewing component.

10. A method of continuously measuring a distance to a target object and adjusting a lens coupled to a motion camera to maintain a continuous focus on the target object, the method comprising:
continuously obtaining, by a processing device, data from one or more infrared components, wherein the data corresponds to the distance between the target object and the lens coupled to the motion camera;
determining, by the processing device, one or more position parameters of the lens that corresponds to a focused image of the target object, and
transmitting, by the processing device, the one or more position parameters to a lens controller, thereby causing the lens controller to adjust a positioning of the lens to correspond to the position parameters.

11. The method of claim 10, further comprising:
determining, by the processing device, an offset distance between the measuring device and the lens.

12. The method of claim 11, wherein determining the one or more position parameters of the lens further comprises determining, by the processing device, the one or more position parameters of the lens based on the offset distance between the measuring device and the lens.

13. The method of claim 10, wherein continuously obtaining the data from one or more infrared components further comprises continuously obtaining, by the processing device, the data from one or more infrared components only when a signal is received from a triggering device.

14. The method of claim 10, wherein determining the one or more position parameters of the lens that corresponds to a focused image of the target object further comprises:
obtaining, by the processing device, calibration data that is specific to the lens; and
determining, by the processing device, the one or more position parameters of the lens based on the calibration data.

15. A system comprising:
a measuring device comprising:
one or more infrared components that generate and receive one or more infrared signals for measuring a distance, and
a processing device for receiving data from the one or more infrared components, determining a distance, and transmitting one or more signals; and
a motion camera comprising:
a lens,
a lens ring that adjusts one or more of a focus, a zoom, and an aperture of the lens, and
a lens controller coupled to the lens ring, the lens controller configured to move the lens ring,
wherein the measuring device continuously:
determines a distance between a target object and the lens,
determines lens ring position parameters that correspond to the distance, and
transmits signals to the lens controller for adjusting a positioning of the lens ring to correspond with the position parameters.

16. The system of claim 15, wherein the one or more infrared components comprise an infrared emitter and an infrared receiver, wherein the infrared emitter emits the one or more infrared signals toward the target object and the infrared receiver receives the one or more infrared signals that have reflected off the target object.

17. The system of claim 15, wherein the measuring device further comprises a user interface display for providing information and receiving one or more inputs.

18. The system of claim 15, wherein the measuring device further comprises a user interface comprising a triggering device, wherein the measuring device continuously determines the distance between the target object and the lens only when a signal is received from the triggering device.

19. The system of claim 15, wherein the measuring device further comprises a viewing component for providing a user with an ability to see the one or more infrared signals and receive system state information.

20. The system of claim 15, wherein:
the motion camera is communicatively coupled to the measuring device, and
the motion camera is not physically coupled to the measuring device.
